(19) United States
(12) Patent Application Publication
(10) Pub. No.: US 2023/0064167 A1
(43) Pub. Date: Mar. 2, 2023

(54) SYSTEMS AND METHODS FOR VULNERABLE COMPUTER SYSTEM EARLY WARNING DETECTION

(71) Applicant: Ahmed Kamel, Seattle, WA (US)

(72) Inventor: Ahmed Kamel, Seattle, WA (US)

(21) Appl. No.: 17/898,238

(22) Filed: Aug. 29, 2022

Related U.S. Application Data
(60) Provisional application No. 63/238,225, filed on Aug. 30, 2021.

(51) Int. Cl. G06Q 20/36; H04L 9/40

(52) U.S. Cl. CPC G06Q 20/3678; H04L 63/1433; G06Q 2220/00

(57) ABSTRACT

A system for detecting intrusions in secure networked computing systems is provided. Also provided are a method for detecting intrusions in secure networked computing systems and a computer-readable medium including instructions for detecting intrusions in secure networked computing systems. The method of detection includes placing cryptocurrency in plain site within the secure networked computing system to provide an incentive for an intruder to steal the cryptocurrency and thus provide a notification of the intrusion.

### CROSS-REFERENCE TO RELATED APPLICATIONS

This application claims the benefit of U.S. Provisional Patent Application No. 63/238,225, filed Aug. 30, 2021, the contents of which are incorporated herein by reference in its entirety.

### BACKGROUND

The field of the present disclosure is related to networked computer systems and more particularly to systems, apparatuses, and methods for detecting intrusions in secure networked computing systems.

### BRIEF DESCRIPTION OF THE DRAWINGS

FIG. 1 schematically illustrates a network of computers and computer assets, in accordance with some embodiments.

FIG. 2 schematically illustrates a network of computers and computer assets with cryptocurrency data for intrusion detection, in accordance with some embodiments.

FIG. 3 shows operations for detecting intrusion on a first target computer asset, in accordance with some embodiments.

### DETAILED DESCRIPTION

The systems, methods, and devices of the present disclosure each have several aspects, no single one of which is solely responsible for its desirable attributes. Without limiting the scope of this disclosure as expressed by the claims that follow, some features will now be discussed briefly. After considering this discussion, and particularly after reading this section, one will understand how the features of this disclosure provide advantages that include improved monitoring of data, files, and information secured in a public or private computerized system.

Embodiments of the present disclosure provide techniques for detecting computer system intrusions. As computer technology has advanced, techniques for criminals and other bad actors to steal valuable data and extort payments from computer owners and operators have also advanced. In some cases of cybercrime, criminals access valuable private data and sell or publish the private data. In some other cases of cybercrime, criminals cause valuable data to be encrypted and demand payment in exchange for providing the victim encryption keys to decrypt their own data. In many cases of cybercrime, the criminals have established access to a victim's computer or network of computers for a long period of time before executing their crimes.

Criminals frequently access a victim's computer via the Internet. In a network of computers operated by an entity (e.g., a company or a governmental agency), there may be several security layers between the Internet and systems storing and accessing valuable data. For example, a company may establish a demilitarized zone (DMZ) where all traffic to or from the Internet is required to traverse a first firewall between the Internet and the DMZ. For example, certain Internet-facing computers, such as web servers, proxy servers, and e-mail servers, may be located in the DMZ. In some examples, the company may separate the DMZ from an internal network by use of a second firewall. Computers on the internal network of the example may access the Internet via the two sets of firewalls or may be restricted from accessing the Internet except via the Internet-facing servers. In some examples, there may also be computers on the internal network that are not authorized to access or be accessed by computers that are not on the internal network. In some example networks of computers, the most valuable data may be stored in the computers that are not authorized to access or be accessed except by other computers on the internal network. Thus, a criminal desiring to access the most valuable data may desire to gain access to two (or more) firewalls and at least one intermediary server. Gaining access to the most valuable data may thus require an investment of time by the criminals, as well as requiring the criminals to maintain access to firewalls, devices in the DMZ, and computers in the internal network. Some criminals have learned to hide their access to computers and devices for extended periods of time, giving the criminals an opportunity to access computers deeper in the victim's network.

Embodiments of the present disclosure provide techniques for detecting intrusions on target computer assets (e.g., computers, firewalls, network devices, data, and data structures). In aspects of the present disclosure, cryptocurrency wallets and tokens are inserted within a network of target computer assets. An intruder (e.g., a criminal or other bad actor) with access to the target computer assets is incentivized to take the cryptocurrency or tokens from the network. The cryptocurrency wallets and tokens are each associated with a target computer asset and are monitored so that, when the intruder takes the cryptocurrency or tokens, the intrusion is detected and localized to the target computer asset associated with the cryptocurrency wallet or token that the intruder took. Target computer assets that are further from the Internet or have access to more valuable data may have more associated cryptocurrency or more valuable associated tokens, increasing the incentive to an intruder to take the cryptocurrency and expose the intrusion as the intruder penetrates deeper into the network. When the cryptocurrency is removed from any cryptocurrency wallet or a token is removed, the monitoring system removes the cryptocurrency from all other wallets and removes all other tokens.

According to some embodiments, a method for detecting intrusion on a target computer asset is provided. The method may include: storing a cryptocurrency wallet having a first quantity of cryptocurrency on the target computer asset; detecting that the first quantity of cryptocurrency has been removed from the first cryptocurrency wallet; and determining that an intrusion of the first target computer asset has occurred, based on detecting that the first quantity of cryptocurrency has been removed from the first cryptocurrency wallet.

In some embodiments of the present disclosure, a system for detecting intrusion on a target computer asset is provided. The system may include: a memory storing computer-executable instructions to perform operations including: storing a cryptocurrency wallet having a first quantity of cryptocurrency on the target computer asset; detecting that the first quantity of cryptocurrency has been removed from the first cryptocurrency wallet; and determining that an intrusion of the first target computer asset has occurred, based on detecting that the first quantity of cryptocurrency has been removed from the first cryptocurrency wallet; and a processing system configured to execute the instructions.

In some embodiments, the system for detecting intrusion on a target computer asset may periodically withdraw a small quantity of cryptocurrency from a cryptocurrency wallet, until the amount of cryptocurrency remaining in the wallet drops below a threshold, and then the system restores the first quantity of cryptocurrency in the cryptocurrency wallet. By periodically reducing an amount of cryptocurrency in a cryptocurrency wallet, the system may further incentivize an intruder to take the cryptocurrency and reveal the intrusion, since the intruder sees the quantity of cryptocurrency available to take as steadily decreasing unless the intruder sees the system restore the first quantity of cryptocurrency in the cryptocurrency wallet.

As used herein, a first computer is “connected with” a second computer if the first computer may make a network connection (e.g., at a physical (PHY) layer, medium access control (MAC) layer, or Internet layer of the Open Systems Interconnection (OSI) model) to the second computer. If the first computer requires permission from an intermediate device (e.g., a firewall) to the second computer, then the first computer is not “connected with” the second computer, as used herein.

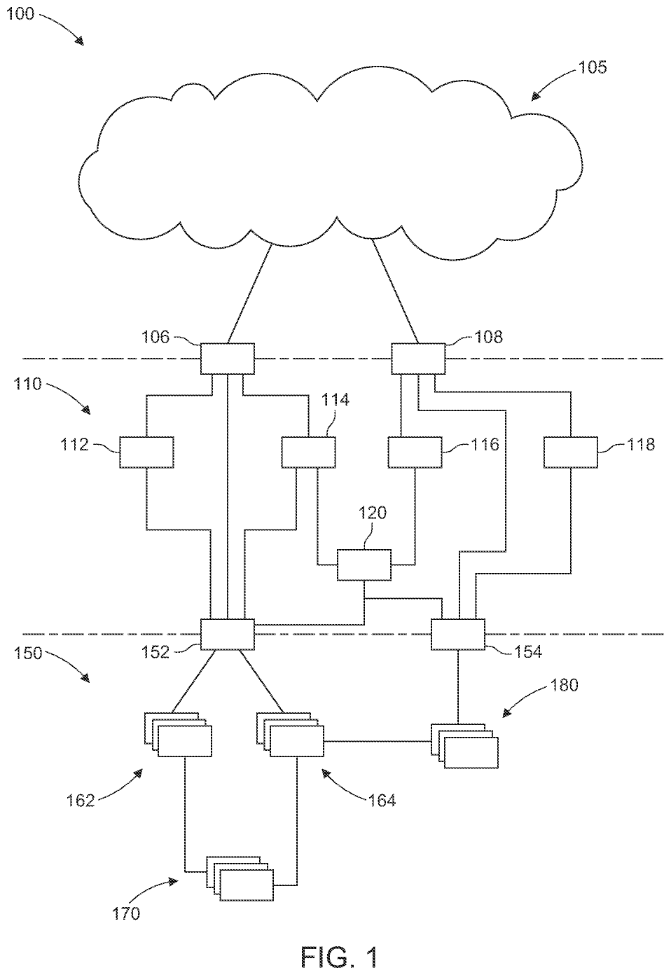

FIG. 1 schematically illustrates an example network 100 of computers and computer assets, according to embodiments of the present disclosure. In the example network 100, the Internet is shown at 105. A DMZ 110 of the network 100 is separated from the Internet 105 by a pair of firewalls 106 and 108. Internet-facing computers (e.g., one or more e-mail servers, web servers, and/or proxy servers) 112, 114, 116, and 118 are located in the DMZ and connected with the firewalls 106 and 108. The Internet-facing computers make and receive connections to the Internet 105 via one of the firewalls 106 and 108. A computer 120 that supports the Internet-facing computers 114 and 116 may be connected to the Internet-facing computers 114 and 116 and may not be connected to the firewalls 106 and 108. An internal network 150 of the network 100 may be separated from the DMZ 110 by a pair of firewalls 152 and 154. The firewalls 152 and 154 may be connected with the firewalls 106 and 108 so that computers 162, 164, and 180 on the internal network 150 that use connections to the Internet 105 can connect to the Internet 105 via the firewalls 106, 108, 152, and 154. Internal servers 162 and 164 are connected with the firewall 152, while individual users' personal computers 180 are connected with the firewall 154. Servers 170 that do not use connections to the Internet 105 may support servers 162 and 164. Servers 170 are not connected with the firewalls 152 or 154. Thus servers 170 may store or access the most valuable data of the network 100 and have the most protection from connections from the Internet.

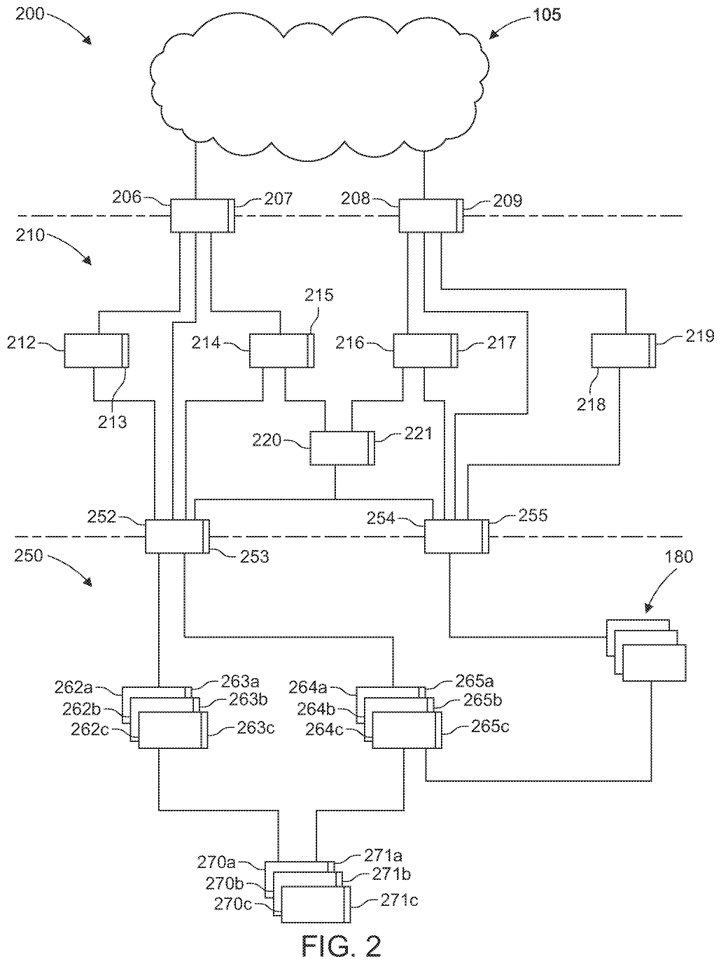

FIG. 2 schematically illustrates an example network 200 of computers and computer assets with cryptocurrency data (e.g., cryptocurrency wallets or tokens) for intrusion detection, according to some embodiments of the present disclosure. In the example network 200, the Internet is shown at 105. A DMZ 210 of the network 200 is separated from the Internet 205 by a pair of firewalls 206 and 208. Firewall 206 is associated with cryptocurrency data 207, and firewall 208 is associated with cryptocurrency data 209. Internet-facing computers (e.g., e-mail servers, web servers, and proxy servers) 212, 214, 216, and 218 may be located in the DMZ and connected with the firewalls 206 and 208. The Internet-facing computers make and receive connections to the Internet 205 via one of the firewalls 206 and 208. Internet-facing computers 212, 214, 216, and 218 are associated with cryptocurrency data 213, 215, 217, and 219, respectively. A computer 220 that supports the Internet-facing computers 214 and 216 is connected to the Internet-facing computers 214 and 216 and is not connected to the firewalls 206 and 208. The computer 220 is associated with cryptocurrency data 221. An internal network 250 of the network 200 is separated from the DMZ 210 by a pair of firewalls 252 and 254. The firewalls 252 and 254 are connected with the firewalls 206 and 208 so that computers 262, 264, and 180 on the internal network 250 that use connections to the Internet 105 can connect to the Internet 105 via the firewalls 206, 208, 252, and 254. Firewalls 252 and 254 are associated with cryptocurrency data 253 and 255, respectively. Internal servers 262 and 264 are connected with the firewall 252, while individual users' personal computers 180 are connected with the firewall 254. Each of the internal servers 262 are associated with corresponding cryptocurrency data 263. Similarly, each of the internal servers 264 are associated with corresponding cryptocurrency data 265. Users' personal computers 180 and other computers (not shown) that lack access to valuable data may not be associated with cryptocurrency data, although in some cases, there may be cryptocurrency associated with users' personal computers 180. Servers 270 that do not use connections to the Internet 105 may support servers 262 and 264. Each of the servers 270 may be associated with corresponding cryptocurrency data 271. Servers 270 are not connected with the firewalls 252 or 254. Thus, servers 270 may store or access the most valuable data of the network 100 and have the most protection from connections from the Internet. Server 270a may, for example, monitor the various cryptocurrency data, as described in more detail herein.

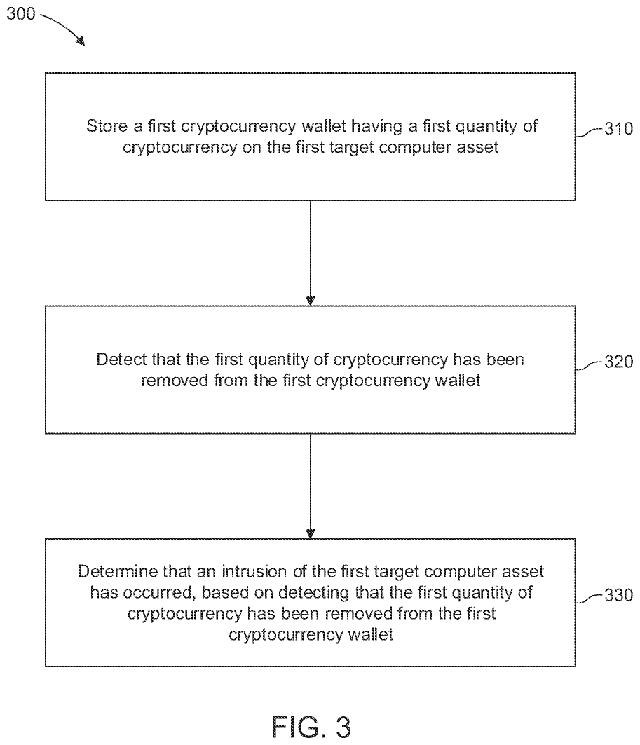

FIG. 3 shows operations 300 for detecting intrusion on a first target computer asset, according to aspects of the present disclosure. Operations 300 may be performed by a computer (e.g., server 270a, see FIG. 2) or other device configured to monitor for intrusions in a network (e.g., network 200, see FIG. 2).

At block 310, operations 300 begin with storing a first cryptocurrency wallet having a first quantity of cryptocurrency on the first target computer asset. For example, server 270a (see FIG. 2) stores a first cryptocurrency wallet (e.g., cryptocurrency data 221, see FIG. 2) having a first quantity of cryptocurrency on the first target computer asset (e.g., server 220, see FIG. 2).

Operations 300 continue at block 320 with detecting that the first quantity of cryptocurrency has been removed from the first cryptocurrency wallet. Continuing the example from above, server 270a (see FIG. 2) detects that the first quantity of cryptocurrency (see block 310) has been removed from the first cryptocurrency wallet (e.g., cryptocurrency data 221, see FIG. 2).

At block 330, operations 300 continue with determining that an intrusion of the first target computer asset has occurred, based on detecting that the first quantity of cryptocurrency has been removed from the first cryptocurrency wallet. Continuing the example from above, server 270a (see FIG. 2) determines that an intrusion of the first target computer asset (e.g., server 220, see FIG. 2) has occurred, based on detecting that the first quantity of cryptocurrency (see block 310) has been removed (see block 320) from the first cryptocurrency wallet (e.g., cryptocurrency data 221, see FIG. 2).

According to some embodiments, one or more target computer asset (e.g., a target computer or a target data structure, such as a database) may have an associated crypto address and a crypto private key. An intruder accessing the crypto address using the crypto private key can withdraw the cryptocurrency or token.

In some examples, each target computer asset's associated crypto address and private key may be stored in a location that is only accessible if the target computer asset has been compromised. For example, a target computer asset that is a computer may have an associated crypto address and private key stored in local storage of the computer. In another example, a target computer asset that is a database may have an associated crypto address and private key stored in a table of the database. In other words, in some cases, the cryptocurrency may be placed in plain site so that an intruder will find the cryptocurrency and be incentivized to take the cryptocurrency.

According to aspects of the present disclosure, each target computer asset may be assessed a value. The value may be based upon numerous factors, such as the level of protection of the computer asset, the quality of the data stored on the target computer asset, the quantity of data stored on the target computer asset, among other factors. Crypto addresses may be funded in proportion to their target computer asset's assessed value. For example, server 270b (see FIG. 2) may be assessed a value of 5 and may have $5000 of cryptocurrency in the associated cryptocurrency data 271b, while server 218 may be assessed a value of 1 and may have $1000 of cryptocurrency in the associate cryptocurrency data 219.

In aspects of the present disclosure, each target computer asset's associated crypto address may be monitored by a monitoring system.

According to examples of the present disclosure, crypto addresses and private keys may be periodically cycled. That is, crypto addresses and private keys of target computer assets may be periodically changed. Consequently, where an intruder sees an available crypto address, if the intruder loiters too long within the system, the intruder may see that the crypto currency is no longer available. This may provide additional incentive for the intruder to take the cryptocurrency when it is available, or risk not being able to take any cryptocurrency. Furthermore, the longer an intruder lurks within a network, the higher the likelihood that the intrusion will be discovered, in which case, the network operator may detect the intrusion and secure the computing system thus removing the availably of the cryptocurrency to the intruder all together.

In aspects of the present disclosure, target computer asset owners can trigger a target computer asset's suspected compromise alarm. That is, an owner of a target computer asset can trigger a suspected compromise alarm for that target computer asset, and the monitoring system may be configured to remove the cryptocurrency from the cryptocurrency data associated with that target computer asset. The monitoring system may also be configured to take other steps to secure the target computer asset (e.g., updating network configurations to prevent access to the target computer asset). In some cases, the monitoring system may be configured to remove the cryptocurrency from all target computer assets within a network until the network can be secured.

According to aspects of the present disclosure, a suspected compromise alarm may force a fund (e.g., cryptocurrency) withdrawal from a target computer asset's address.

In aspects of the present disclosure, a customer that suspects an intrusion on a target computer asset that the customer uses but does not own may trigger a target computer asset's suspected compromise alarm. For example, a customer of a cloud storage service that determines their non-public data is available on the Internet may trigger a suspected compromise alarm for the cloud storage service. In aspects of the present disclosure, after a customer triggers a suspected compromise alarm, then a timer may be started. Upon expiration of the timer, a monitoring system may issue and distribute new crypto addresses and private keys to each of the target computer assets and transfer funds from old addresses to new addresses.

According to aspects of the present disclosure, the first target computer asset of block 310 may be a computer system (e.g., a server).

In aspects of the present disclosure, the first target computer asset of block 310 may be a data structure (e.g., a database) stored on a computer system.

According to aspects of the present disclosure, a system performing operations 300 may assign a first crypto address and a first crypto private key to the first target computer asset and store the first crypto address and the first crypto private key in a location that is only accessible when the first target computer asset has been compromised (e.g., an intruder has gained access). The system performing operations 300 may monitor the first crypto address, and by the monitoring the system may detect that the first quantity of cryptocurrency has been removed from the first cryptocurrency wallet, as in block 320. The system performing operations 300 may assign a second crypto address and a second crypto private key to the first target computer asset, based on an elapsed time since the first crypto address and the second crypto key were assigned to the first target computer asset.

In aspects of the present disclosure, a system performing operations 300 may detect that the first quantity of cryptocurrency has been removed from the first cryptocurrency wallet, as in block 320, by detecting a change in a blockchain of transactions.

According to some embodiments, a system performing operations 300 may determine a first value of the first target computer asset and determine the first quantity of cryptocurrency of block 310 based on the first value. The system performing operations 300 may determine a second value of a second target computer asset; determine a second quantity of cryptocurrency based on the second value; and store a second cryptocurrency wallet having the second quantity of cryptocurrency on the second target computer asset. The system performing operations 300 may determine the first value or the second value based on a distance of a location of the first target computer asset or the second target computer asset in a network from an edge of the computer network.

In aspects of the present disclosure, a system performing operations 300 may receive a suspected compromise alarm for the first target computer asset and withdraw the first quantity of cryptocurrency from the first cryptocurrency wallet in response to the suspected compromise alarm.

According to some embodiments of the present disclosure, a system performing operations 300 may periodically withdraw a second quantity of cryptocurrency, less than the first quantity, from the first cryptocurrency wallet and, when the first cryptocurrency wallet stores less than a threshold amount of cryptocurrency, storing the first quantity of cryptocurrency in the first cryptocurrency wallet.

In some cases, a monitoring system can oversee several computer networks. For example, a monitoring service can oversee networks operated by individual clients. In some cases, a single crypto address may be distributed across more than one networked computer system. That is, a single crypto address may be provided within different networks operated by different entities. The monitoring service may watch for a withdrawal of the crypto currency from each of the monitored networks and trigger an alarm when the cryptocurrency is withdrawn.

The systems and methods described herein incentivize a network intruder to make his presence known by making crypto address and crypto private keys easily accessible to the intruder. Upon taking the cryptocurrency, the presence of the intruder is then immediately known and the location of the intrusion is likewise known. In some cases, small dollar amount crypto wallets may be placed around the periphery of a network, such as at computing systems having relatively low value (e.g., email servers, marketing information, and the like. For computing system or data structures having a relatively higher value (e.g., customer email databases, customer credit score, financial information, etc.) crypto wallets having higher dollar amounts may be associated with these higher value target computers. Where a less-sophisticated intruder is able to penetrate the periphery of a computer system, there will be incentive to take the cryptocurrency and trigger an intrusion alarm, at which time, the network operator can secure the system and prevent future intrusions. In some cases, where an intrusion is detected, the network operator can remove all the cryptocurrency from the network and the intruder is left with nothing, thereby further providing an incentive for an intruder to take the cryptocurrency sooner, rather than loitering within a network and risk getting nothing.

The accompanying drawings are part of the disclosure and are incorporated into the present specification. The drawings illustrate examples of embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments but should be defined only in accordance with the following claims and their equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also comprise additional steps in addition to those disclosed. Further, a step of any method as disclosed herein can be combined with any one or more steps of any other method as disclosed herein.

According to some example embodiments, the systems and/or methods described herein may be under the control of one or more processors. The one or more processors may have access to computer-readable storage media (“CRSM”), which may be any available physical media accessible by the processor(s) to execute instruction stored on the CRSM. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other medium which can be used to store the desired information and which can be accessed by the processor(s).

Those skilled in the art will appreciate that, in some implementations, the functionality provided by the processes and systems discussed above may be provided in alternative ways, such as being split among more software programs or routines or consolidated into fewer programs or routines. Similarly, in some implementations, illustrated processes and systems may provide more or less functionality than is described, such as when other illustrated processes instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other implementations the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some implementations, illustrated data structures may store more or less information than is described, such as when other illustrated data structures instead lack or include such information respectively, or when the amount or types of information that is stored is altered. The various methods and systems as illustrated in the figures and described herein represent example implementations. The methods and systems may be implemented in software, hardware, or a combination thereof in other implementations. Similarly, the order of any method may be changed, and various elements may be added, reordered, combined, omitted, modified, etc., in other implementations.

1. A computer-implemented method for detecting intrusion on a first target computer asset, the method comprising:
storing a first cryptocurrency wallet having a first quantity of cryptocurrency on the first target computer asset;
detecting that the first quantity of cryptocurrency has been removed from the first cryptocurrency wallet; and
determining that an intrusion of the first target computer asset has occurred, based on detecting that the first quantity of cryptocurrency has been removed from the first cryptocurrency wallet.

2. The method of claim 1, wherein the first target computer asset comprises a computer system.

3. The method of claim 1, wherein the first target computer asset comprises a data structure stored on a computer system.

4. The method of claim 1, further comprising:
assigning a first crypto address and a first crypto private key to the first target computer asset; and
storing the first crypto address and the first crypto private key in a location that is only accessible when the first target computer asset has been compromised.

5. The method of claim 4, further comprising:
monitoring the first crypto address, wherein detecting that the first quantity of cryptocurrency has been removed from the first cryptocurrency wallet is detected by the monitoring.

6. The method of claim 4, further comprising:
assigning a second crypto address and a second crypto private key to the first target computer asset, based on an elapsed time since the first crypto address and the second crypto private key were assigned to the first target computer asset.

7. The method of claim 1, further comprising:
determining a first value of the first target computer asset; and
determining the first quantity of cryptocurrency based on the first value.

8. The method of claim 7, further comprising:
determining a second value of a second target computer asset;
determining a second quantity of cryptocurrency based on the second value; and
storing a second cryptocurrency wallet having the second quantity of cryptocurrency on the second target computer asset.

9. The method of claim 7, wherein:
the first target computer asset is at a location in a computer network; and
determining the first value is based on a distance of the location from an edge of the computer network.

10. The method of claim 1, further comprising:
receiving a suspected compromise alarm for the first target computer asset; and
withdrawing the first quantity of cryptocurrency from the first cryptocurrency wallet in response to the suspected compromise alarm.

11. The method of claim 1, further comprising:
periodically withdrawing a second quantity of cryptocurrency, less than the first quantity, from the first cryptocurrency wallet; and
when the first cryptocurrency wallet stores less than a threshold amount of cryptocurrency, storing the first quantity of cryptocurrency in the first cryptocurrency wallet.

12. A system for detecting intrusion on a first target computer asset, the system comprising:
a memory storing computer-executable instructions to perform operations including:
storing a first cryptocurrency wallet having a first quantity of cryptocurrency on the first target computer asset;
detecting that the first quantity of cryptocurrency has been removed from the first cryptocurrency wallet; and
determining that an intrusion of the first target computer asset has occurred, based on detecting that the first quantity of cryptocurrency has been removed from the first cryptocurrency wallet; and
a processing system configured to execute the instructions.

13. The system of claim 12, wherein the first target computer asset comprises a computer system.

14. The system of claim 12, wherein the first target computer asset comprises a data structure stored on a computer system.

15. The system of claim 12, wherein the operations further comprise:
assigning a first crypto address and a first crypto private key to the first target computer asset; and
storing the first crypto address and the first crypto private key in a location that is only accessible if the first target computer asset has been compromised.

16. The system of claim 15, wherein the operations further comprise:
monitoring the first crypto address, wherein detecting that the first quantity of cryptocurrency has been removed from the first cryptocurrency wallet is detected by the monitoring.

17. The system of claim 15, wherein the operations further comprise:
assigning a second crypto address and a second crypto private key to the first target computer asset, based on an elapsed time since the first crypto address and the second crypto private key were assigned to the first target computer asset.

18. The system of claim 12, wherein the operations further comprise:
determining a first value of the first target computer asset; and
determining the first quantity of cryptocurrency based on the first value.

19. The system of claim 18, wherein the operations further comprise:
determining a second value of a second target computer asset;
determining a second quantity of cryptocurrency based on the second value; and
storing a second cryptocurrency wallet having the second quantity of cryptocurrency on the second target computer asset.

20. The system of claim 18, wherein:
the first target computer asset is at a location in a computer network; and
determining the first value is based on a distance of the location from an edge of the computer network.

21. The system of claim 12, wherein the operations further comprise:
receiving a suspected compromise alarm for the first target computer asset; and
withdrawing the first quantity of cryptocurrency from the first cryptocurrency wallet in response to the suspected compromise alarm.

22. The system of claim 12, wherein the operations further comprise:
periodically withdrawing a second quantity of cryptocurrency, less than the first quantity, from the first cryptocurrency wallet; and
when the first cryptocurrency wallet stores less than a threshold amount of cryptocurrency, storing the first quantity of cryptocurrency in the first cryptocurrency wallet.
